(19) United States
(12) Patent Application Publication
(10) Pub. No.: US 2008/0156375 A1
(43) Pub. Date: Jul. 3, 2008

(54) Outlet Connection for a Container

(76) Inventors: Hans-Peter Wild, Eppelheim (DE); Wolfgang Tilz, Schwetzingen (DE)

Correspondence Address: STROOCK & STROOCK & LAVAN LLP, 180 MAIDEN LANE, NEW YORK, NY, 10038, US

(21) Appl. No.: 11/936,654

(22) Filed: Nov. 7, 2007

(30) Foreign Application Priority Data
Nov. 7, 2006 (EP) 06023158.6
Mar. 15, 2007 (DE) 202007003840.2

(51) Int. Cl. F16K 17/40; F16K 17/42; F16K 17/16; B26D 3/08; B21D 51/16

(52) U.S. Cl. 137/68.27; 83/861; 29/890.12

(57) ABSTRACT

An outlet connector for a container is provided through which a product can be introduced into the container through the outlet connector. The outlet connector preferably includes a sealing mechanism that can burst once a threshold pressure is exceeded, for example, by the flow of products toward the container. A sealing mechanism is described herein having two layers, wherein one layer is perforated to provide a defined tearing of the sealing mechanism. A method of producing an outlet connector is also provided herein.

### BACKGROUND OF THE INVENTION

This invention relates, in general, to an outlet connector for a container, wherein a product is supplied into the container via the outlet connector.

A filling system is typically connected to the outlet connector to supply the product therethrough into the container. Prior to connecting the filling system to the outlet connector, the seal of the outlet connector is removed to expose the opening into the container. A drawback of such a system is that ambient air from the surrounding can enter the container, thus potentially compromising the aseptic state of the container.

In light of the shortcomings described above, it is desirable to provide an improved outlet connector to reduce the likelihood of compromising the aseptic state of the connector, and a method of producing the improved outlet connector.

### SUMMARY

Generally speaking, the present invention is directed toward a sealing mechanism and an outlet connector for a container having a sealing mechanism that does not require removal before filling the container with a product. Preferably, the pressure of the product flowing toward the container can rupture the sealing mechanism or otherwise open a flow opening through which the product can flow into the container. In accordance with an embodiment of the invention, the sealing mechanism comprises multiple layers, for example, a multiple-layer foil, having at least one layer that is perforated or otherwise weakened at certain places such that the sealing mechanism can burst open along the perforation or weakened area. The second layer preferably does not comprise such perforation or weakened area, thus preventing the exchange of air or germs between the container and the surroundings until after the sealing mechanism is burst open by the product flow.

Preferably, the sealing mechanism can withstand pressure up to a threshold pressure, such that once the threshold pressure is exceeded, the sealing mechanism can burst open, and not at a lower temperature.

A method of producing the outlet connector having the sealing mechanism described above is also described herein. More specifically, a multiple layer foil can be provided having at least two layers, after which at least one layer is perforated or otherwise weakened to provide controlled separation of the foil along the perforation or weakened area.

An object of the invention is to provide an improved outlet connector as described herein.

Other objects and features of the present invention will become apparent from the following detailed description, considered in conjunction with the accompanying drawing figure. It is to be understood, however, that the drawings are designed solely for the purpose of illustration and not as a definition of the limits of the invention, for which reference should be made to the appended claims.

### BRIEF DESCRIPTION OF THE FIGURES

For a fuller understanding of the invention, reference is had to the following description, taken in connection with the accompanying drawings, in which:

FIG. 1 is a perspective cross-sectional view of a connector in accordance with an embodiment of the invention;

FIG. 2 is another perspective cross-sectional view of the connector of FIG. 1;

FIG. 3 is a perspective cross-sectional view of a connector in accordance with an embodiment of the invention;

FIG. 4a is a top view of a connector in accordance with an embodiment of the invention;

FIG. 4b is a top view of a connector in accordance with another embodiment of the invention;

FIG. 4c is a top view of a connector in accordance with another embodiment of the invention;

FIG. 4d is a top view of a connector in accordance with another embodiment of the invention;

FIG. 4e is a top view of a connector in accordance with another embodiment of the invention;

FIG. 4f is a top view of a connector in accordance with another embodiment of the invention;

FIG. 4g is a top view of a connector in accordance with another embodiment of the invention;

FIG. 5 is a perspective view of a container and a connector in accordance with an embodiment of the invention; and

FIG. 6 is a schematic diagram of a method of producing a connector in accordance with an embodiment of the invention.

### DETAILED DESCRIPTION

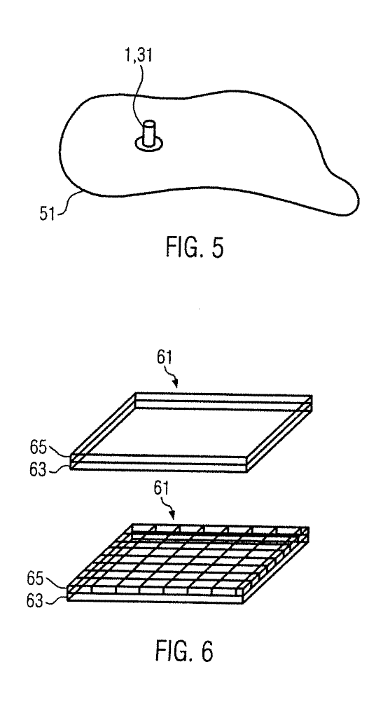

Reference is made to FIGS. 1-3, wherein embodiments of a connector generally indicated at 1, 31 are illustrated. As shown, connector 1, 31, for example, an outlet connector, can include a conduit 3 through which a product may flow toward a container 51 (see FIG. 5). Conduit 3 is preferably generally cylindrical in shape and is connected at a first end to a ring 5. Ring 5 is preferably constructed and arranged to be secured to container 51 such that conduit 3 extends away from container 51. In accordance with an exemplary embodiment, connector 1 is attached to, preferably sealed with, container 51. For example, the side of ring 5 facing conduit 3 can be attached to container 51 and sealed therewith to retain connector 1 in position relative to container 51.

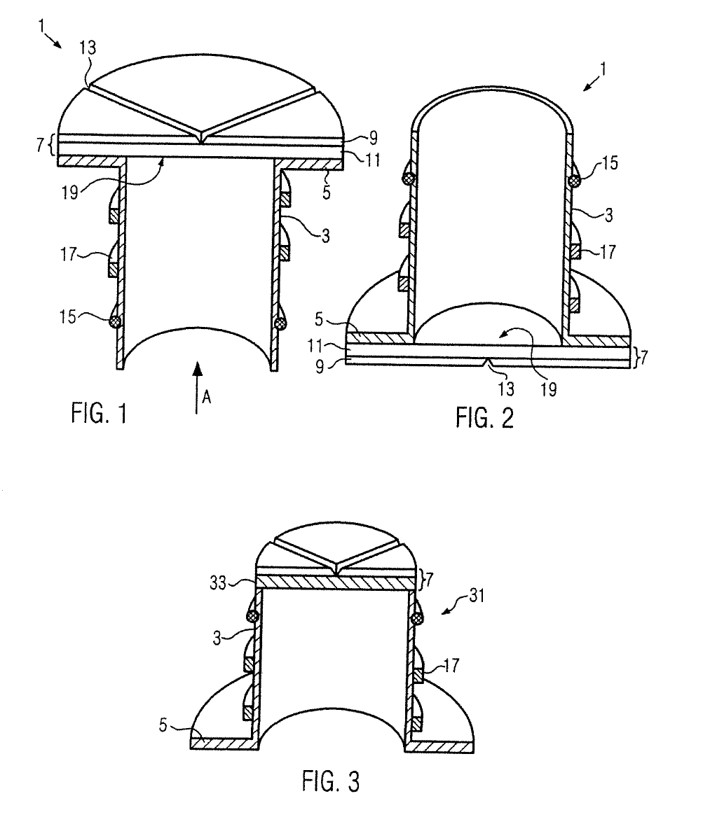

Referring to FIGS. 1-2, a sealing mechanism 7 can be provided on ring 5 to seal conduit 3 and thus container 51 to which connector 1 is attached. Sealing mechanism 7 is preferably generally circular in shape to correspond to the shape of ring 5. In the embodiment shown, sealing mechanism 7 is attached on the side of ring 5 that faces away from conduit 3 and toward container 51. FIG. 3 shows an alternate embodiment of connector 31 having sealing mechanism 7 attached to the opposite end of conduit 3 from ring 5. Accordingly, the position of sealing mechanism 7 can be altered as a matter of application specific design choice and is not limited to the embodiments shown and described herein.

Among many embodiments, sealing member 7 can be a foil, for example, a multiple layer foil. Sealing member 7 preferably includes at least two layers, a first layer 9 and a second layer 11. In accordance with the embodiment shown in FIGS. 1-2, second layer 11 can be attached to ring 5 and form a seal, thus sealing conduit 3 proximate ring 5. Alternatively, as shown in FIG. 3, second layer 11 can be attached to the opposite end of conduit 3 thus sealing the end of conduit 3 away from ring 5. Such a configuration preferably reduces the surface area of sealing mechanism 7 that is sterilized prior to filling container 51 with the product.

As shown in FIGS. 1-3, first layer 9 of sealing mechanism 7 can be attached to second layer 11 on the opposite side of second layer 11 from conduit 3. As shown, first layer 9 preferably includes one or more perforations 13 or weakened areas that are more vulnerable to tear when a certain amount of pressure is applied.

Conduit 3 can also include a connecting thread 17 and a seal 15 on the outer wall of conduit 3. Preferably, a filling or emptying device (not shown) can be connected to connector 1, 31, the filling or emptying device constructed and arranged to connect to connector 1, 31 via connecting thread 17 and seal 15. Preferably, conduit 3, ring 5 and thread 17 are a unitary piece. However, one or more elements can be provided as a discrete part without deviating from the scope of the invention. For example, each of conduit 3, ring 5 and thread 17 can be formed separately and assembled to produce connector 1. Alternatively, conduit 3 and ring 5 can be an integral piece and thread 17 can be assembled therewith. Other combinations thereof are contemplated herein and do not deviate from the scope of the invention.

Perforation 13 of first layer 9 of sealing mechanism 7 preferably facilitates bursting sealing mechanism in a defined manner along perforation 13 and prevents shredding of sealing mechanism 7 when a threshold pressure is exceeded. Therefore, preferably no pieces of sealing mechanism 7 enters container 51. Referring to FIG. 1, a product can flow in direction A through conduit 3 toward side 19 of second layer 11. Pressure can build up against side 19 as the product continues to be supplied. Preferably, sealing mechanism 7 is weakest at perforation 13, and once a certain pressure exceeds the threshold pressure of sealing mechanism 7, sealing mechanism 7 can tear proximate or at perforation 13.

The threshold pressure of sealing mechanism 7 can be affected by, among other factors, the thickness of layers 9, 11, more specifically the thickness of second layer 11 and the shape of the perforation pattern. In accordance with an exemplary embodiment, first layer 9 of sealing mechanism 7 has a thickness of about 10 to 15 μm, more preferably about 12 μm. Second layer 11 preferably has a thickness of about 40 to 60 μm. The thickness of the layers can affect the threshold pressure of sealing mechanism 7, and can thus be varied as desired without deviating from the scope of the invention.

Whereas the embodiments described herein comprise a first and second layer 9, 11, more than 2 layers are contemplated. Accordingly, sealing mechanism 7 can comprise more than two layers without deviating from the scope of the invention.

Preferably, sealing mechanism 7 can withstand at least about 100 mbar of pressure. More preferably, sealing mechanism 7 can burst at a pressure of about 300 to 500 mbar. This pressure is preferably greater than the pressure applied during sterilization, for example, the application of hot vapor, hydrogen peroxide, etc. Sealing mechanism 7 can be sterilized via gamma radiation. It is to be understood that the threshold pressure and the pressure range at which sealing mechanism 7 is constructed to burst can vary as a matter of application specific design choice. For example, the threshold pressure can be 2 bar without deviating from the scope of the invention.

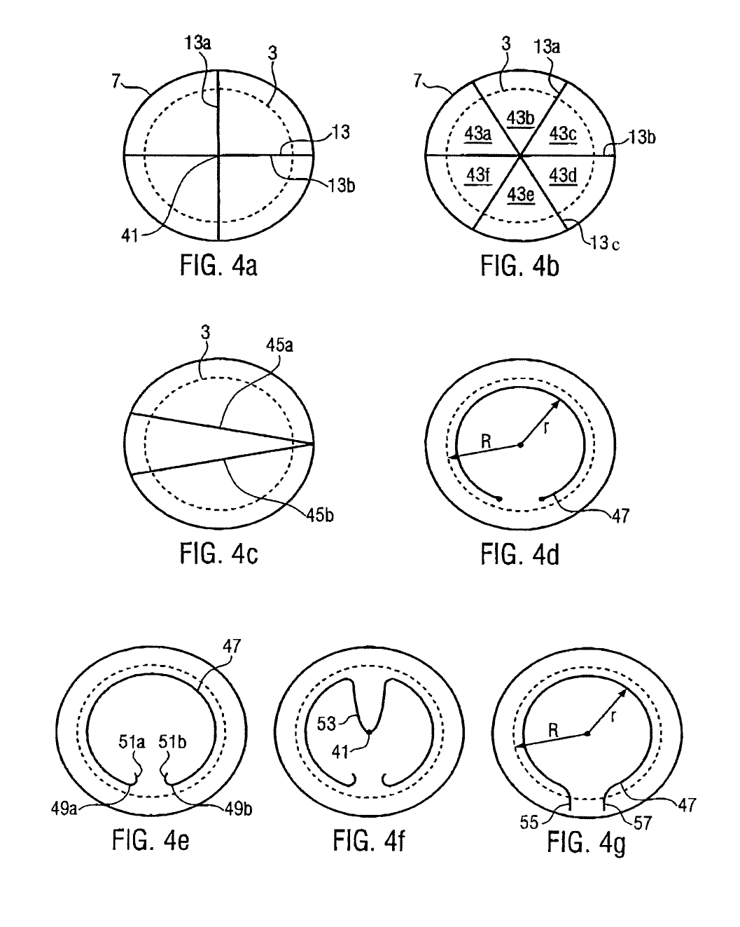

In accordance with an exemplary embodiment, first layer 9 and second layer 11 have different light absorption characteristics. For example, a certain wavelength or wavelength range can be absorbed by one layer while passing through the other layer without being absorbed. Therefore, a light of a certain wavelength or wavelength range can be used to perforate first layer 9 by light absorption without damaging or otherwise weakening second layer 11. High energy light sources can be preferred, such as lasers, for perforating one layer as described herein. Preferably, the layer is perforated in accordance with a predetermined pattern as described in further detail below and shown in FIGS. 4a-g.

First layer 9 is preferably made of polyethylene terephthalate (PET) and second layer 11 is preferably made of polyethylene (PE). It may be preferable to provide a PE second layer 11 which can be attached to the PET first layer 9 by hot sealing or ultrasonic sealing, which preferably provides a tight seal on conduit 3. By providing a PET first layer 9 and a PE second layer 11, perforations 13 can be provided by a laser on the PET first layer while second layer 11 remains undamaged due to their respective light absorption characteristics. In accordance with an alternate embodiment, polyethylene terephthalate polyester (PETP) can be used for first layer 9 and polypropylene (PP) or Linear Low Density polyethylene (LLDPE) can be used for second layer 11.

Preferably, conduit 3, ring 5 and thread 17 are made of plastic, more preferably, of high density polyethylene (HDPE). HDPE may be preferable for use with a PE, PP or LLDPE second layer 11 because PE, PP and LLDPE can be affixed and sealed with respect to HDPE. It is to be understood that the examples are merely exemplary and other suitable materials can be used for any or all of the components described herein.

FIGS. 4a-4g show certain exemplary embodiments of perforation 13. However, it is to be understood that a variety of shapes, patterns, etc. not illustrated herein can be provided without deviating from the scope of the invention. Referring to FIGS. 4a-4f, the inner circumference of conduit 3 is demonstrated in dashed lines for reference.

FIG. 4a shows a cross shaped perforation 13 consistent with the embodiment shown in FIGS. 1-3. The intersection of cross 41 preferably coincides with the center of conduit 3. Therefore, a relatively large flow opening is provided, thus facilitating the speed at which the container is filled with the product. In the embodiment shown, perforation lines 13a 13b extend beyond the edge of conduit 3 which can further facilitate the speed of the product flowing into container 51.

Referring to FIG. 4b, a plurality of perforations 13a, 13b and 13c can be arranged to form the shape of a star, thus dividing sealing mechanism 7 into several segments. In the embodiment shown, the three perforations 13a, 13b, 13c provide six segments 43a-f of sealing mechanism 7 after it has been ruptured. Such a configuration may provide a larger flow opening than an embodiment having less perforations 13 dividing sealing mechanism 7 into fewer segments, such as the embodiment shown in FIG. 4a. By increasing the number of perforations 13 and/or by reducing the distance between perforations 13, the threshold pressure can be decreased. Preferably, the threshold pressure along sealing mechanism 7 varies slightly according to the density of perforations 13 as described above. Therefore, the weakest portion can burst first, and sealing mechanism 7 can continue to burst along the perforations 13, thus reducing the risk of portions of sealing mechanism 7 tearing off as a result of uncontrolled tearing thereof. It is to be understood that the number of perforations 13, segments provided, and/or the distance between perforations 13 can be varied as a matter of application specific design choice.

An alternate embodiment of the pattern of perforation 13 is illustrated in FIG. 4c, wherein two perforations 13 are provided in the form of two lines 45a,b intersecting at a point outside the perimeter of conduit 3. Such an arrangement can also provide a relatively large flow opening once sealing mechanism 7 bursts along perforation lines 45a,b.

Referring to FIG. 4d, the pattern of perforation 13 is generally a circular arc 47. Arc 47 has an arc radius r that is preferably less than or equal to a conduit radius R of conduit 3. More preferably, radius arc r is approximately 5% smaller than conduit radius R. Therefore, after sealing mechanism 7 bursts, the flow opening can be substantially the same as the cross-sectional area of the interior of conduit 3. As shown, arc 47 is preferably generally an incomplete circle such that sealing mechanism 7 remains intact after bursting, thus preventing the introduction of pieces of sealing mechanism 7 into container 51. As shown in FIG. 4e, arc 47 can include ends 49a,b having open loops 51a,b. Loops 51a,b preferably prevent sealing mechanism 7 from tearing when it bursts. Whereas loops 51a,b are shown as curving inward, it is to be understood that loops 51a,b can curve outward without deviating from the scope of the invention.

Reference is made to FIG. 4f, wherein a variation of arc 47 is illustrated. In the embodiment shown, arc 47 includes a loop 53 that extends toward center 41 of arc 47. Preferably, loop 53 extends into center 41. Loop 53 preferably facilitates the bursting of sealing mechanism 7 by weakening the center of sealing mechanism 7 where the pressure of the product flow is usually the strongest.

Alternatively, according to the embodiment shown in FIG. 4g, arc 47 can have ends 55, 57 extending past conduit 3 onto ring 5. By providing ends 55, 57 on ring 5, a larger flow opening can be provided while reducing the likelihood of undefined tearing of sealing mechanism 7 at the end of perforation 13. It is to be understood that FIGS. 4a-g are merely exemplary and other shapes, arrangements, etc. are envisioned, preferably to reduce the likelihood of shredding of sealing mechanism 7 during bursting.

A relatively large flow opening may be preferable to prevent solid constituents in the product flow, such as fruit, from being stuck proximate outlet connector 1. Therefore, a large flow opening preferably prevents the solid constituents from being damaged, for example, from being crushed, as well as from slowing down the product flow.

Reference is made to FIG. 5, wherein an example of the use of connector 1,31 is shown. Connector 1,31 can be attached to container 51 by inserted connector 1,31 through an opening in bag 51. When connector 1,31 is properly positioned, connector 1,31 can be attached to container via ring 5. Preferably, container 51 and ring 5 are sealed with respect to each other. The opening of container 51 through which connector 1,31 was inserted can be closed thereafter. The interior of container 51 with connector 1,31 attached thereto can be cleaned, preferably sterilized, and maintained sterilized. In accordance with the embodiment shown, container 15 can be a bag. However, it is to be understood that container 51 can be any suitable container for receiving a product, preferably a food product such as, by way of non-limiting example, juices and fruit preparations.

FIG. 6 illustrates a method of preparing sealing mechanism 7. As shown, a multiple-layer foil 61 can be provided having a first layer 65 and a second layer 63. Multiple-layer foil 61 can be produced or purchased pre-manufactured. Preferably, first layer 65 comprises PET and second layer 63 comprises PE, and thus the two layers 65, 63 have different light absorption characteristics. More particularly, first layer 65 is degradable by laser light whereas second layer 63 is resistant to laser light. Laser light, for example, CO₂ laser, can be applied on the multiple-layer foil to perforate first layer 65 while leaving second layer 63 at least substantially unharmed. The resulting multiple-layer foil can then be placed on a connector and sealed therewith to produce connector 1 in accordance with an embodiment of the invention. Alternatively, multiple-layer foil 61 can be attached to the connector prior to perforating first layer 9 without deviating from the scope of the invention. A single sealing mechanism 7 can be produced at a time, or alternatively, multiple sealing mechanisms 7 can be produced at a time to expedite production.

A container for food products is often subject to stringent hygiene requirements. For example, the containers are required to be as germ free as possible, and often required to maintain sterile or aseptic until the container is filled. Therefore, providing an embodiment of a connector 1 described herein can facilitate maintaining container 51 sterile or aseptic prior to being filled.

In accordance with outlet connectors currently available, the sealing mechanism is usually removed from the outlet connector prior to connecting the filling system to the outlet connector, thus potentially introducing ambient air that is not sterilized into the container and compromising the aseptic state of the container. Outlet connector 1 in accordance with an embodiment of the invention, in contrast, maintains the aseptic state by maintaining the container sealed until the container is connected to the filling system and the product is being supplied into the container.

It is to be understood that whereas outlet connector 1 has been described herein with a single sealing mechanism 7, more than one sealing mechanism 7 can be provided in an outlet connector 1 without deviating from the scope of the invention. For example, a sealing mechanism 7 can be provided at both ends of conduit 3 as a matter of application specific design choice.

Additionally, as demonstrated by the embodiments shown in FIGS. 1-2, first layer 9 can face container 51 (FIGS. 1-2) or away from container 51 (FIG. 3) as a matter of application specific design choice.

The examples provided are merely exemplary, as a matter of application specific to design choice, and should not be construed to limit the scope of the invention in any way.

Thus, while there have been shown and described and pointed out novel features of the present invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall therebetween.

1-20. (canceled)

21. An outlet connector for a container, the outlet connector comprising:
a sealing mechanism constructed and arranged to seal the container;
the sealing mechanism having a threshold pressure;
the sealing mechanism further having a first layer and a second layer;
wherein the first layer comprises a predetermined separation site; and
the sealing mechanism being constructed and arranged to separate proximate the separation site when the threshold pressure is exceeded.

22. The outlet connector of claim 21, wherein the first layer and the second layer have different light absorption characteristics.

23. The outlet connector of claim 21, wherein the separation site comprises perforations.

24. The outlet connector of claim 21, wherein the first layer is degradable by laser light and the second layer is resistant to laser light.

25. An outlet connector for a container, the outlet connector comprising:
a sealing mechanism constructed and arranged to provide an aseptic seal, the sealing mechanism having a multiple-layer foil having a threshold pressure, the multiple-layer foil having at least two layers:
wherein one of the at least two layers comprises a perforation at a predetermined location; and
wherein the sealing mechanism is constructed and arranged to burst open along the perforation when the threshold pressure is exceeded.

26. The outlet connector of claim 25, wherein the at least two layers have different light absorption characteristics.

27. The outlet connector of claim 25, wherein the outlet connector further comprises an outlet opening, wherein the second layer covers the outlet opening.

28. The outlet connector of claim 25, wherein the perforation is constructed and arranged to maintain the sealing mechanism connected to the outlet connector as the sealing mechanism bursts open when the threshold pressure is exceeded.

29. The outlet connector of claim 25, wherein the perforation comprises an open circular arc shape.

30. The outlet connector of claim 29, wherein the arc comprises two curved ends, and wherein the curved ends are curved outward.

31. The outlet connector of claim 25, wherein the outlet connector further comprises an outlet opening, and wherein the curved ends extend beyond the outlet opening.

32. The outlet connector of claim 25, comprising at least two perforations having a linear shape.

33. The outlet connector of claim 32, wherein the at least two perforations intersect.

34. The outlet connector of claim 25, wherein the perforation comprises a shape of a star.

35. The outlet connector of claim 25, wherein the perforation comprises a shape of a cross.

36. The outlet connector of claim 35, further comprising an outlet opening, wherein the cross shape is positioned proximate the center of the outlet opening.

37. The outlet connector of claim 25, wherein the first layer comprises polyethylene terephthalate.

38. The outlet connector of claim 25, wherein the second layer comprises one of polyethylene, linear low density polyethylene or polypropylene.

39. The outlet connector of claim 25, further comprising a conduit comprising high density polyethylene.

40. The outlet connector of claim 25, wherein the threshold pressure is at or above about 100 mbar.

41. The outlet connector of claim 25, wherein the threshold pressure is about 300 to 500 mbar.

42. The outlet connector of claim 25, wherein the first layer has a thickness of between about 10 to 15 μm.

43. The outlet connector of claim 25, wherein the first layer has a thickness of about 12 μm.

44. The outlet connector of claim 25, wherein the second layer has a thickness of between about 40 to 60 μm.

45. The outlet connector of claim 25, wherein the second layer has a thickness of about 50 μm.

46. A container having an outlet connect of claim 25.

47. A method of producing a sealing mechanism for application on an outlet connector, the method comprising:
providing a multiple-layer foil having at least two layers, the at least two layers comprising a first layer and a second layer; and
forming a perforation of the first layer at a predetermined position constructed and arranged such that the sealing mechanism bursts open at the perforation when a predetermined pressure is applied thereto.

48. The method of claim 47, further comprising:
providing two layers having different light absorption characteristics;
forming the perforation in the first layer using a laser light; and
maintaining the second layer free from perforations.

49. A sealing mechanism for an outlet connector, the sealing mechanism comprising two layers having different light absorption characteristics.

50. The sealing mechanism of claim 49, wherein one of the two layers comprises a perforation.

51. The sealing mechanism of claim 49, further comprising a multiple-layer foil.
